(19) United States
(12) Patent Application Publication
(10) Pub. No.: US 2023/0171459 A1
(43) Pub. Date: Jun. 1, 2023

(54) PLATFORM FOR VIDEO-BASED STREAM SYNCHRONIZATION

(71) Applicant: Meta Platforms, Inc., Menlo Park, CA (US)

(72) Inventors: Larry Le Chen, Redwood City, CA (US); Nicholas Chang, Santa Clara, CA (US); Eden Siu-Yue Li, San Mateo, CA (US); Jason Nellis, Playa Vista, CA (US)

(21) Appl. No.: 17/537,072

(22) Filed: Nov. 29, 2021

(51) Int. Cl. H04N 21/43; H04N 21/242; H04N 21/2187; H04N 21/2662; H04N 21/485; H04N 7/15

(52) U.S. Cl. CPC H04N 21/4307; H04N 21/242; H04N 21/2187; H04N 21/2662; H04N 21/485; H04N 7/15

(57) ABSTRACT

Methods, systems, and storage media for outputting a synchronized arrangement of a plurality of video streams are disclosed. Exemplary implementations may: select a stage status for a subset of the plurality of client devices; determine, based on the stage status, that a client device of the plurality of client devices is assigned a stage state; send, based on the stage status and the stage state being assigned to the client device, a server state to each client device of the plurality of client devices; determine, based on the server state, a graphical layout comprising a position and size of each video stream of the plurality of video streams to output to a graphical user interface; and provide, to each client device of the plurality of client devices, instructions to display the synchronized arrangement of the plurality of video streams according to the graphical layout.

### TECHNICAL FIELD

The present disclosure generally relates to video-based stream synchronization, and more particularly to outputting a synchronized arrangement of a plurality of video streams.

### BACKGROUND

Conventionally, videotelephony (also referred to as video teleconference or videoconferencing) includes technologies for receiving and transmitting audio-video signals by users in different locations to facilitate real time communications. Typically, live video streams of one or more users may be presented within a single user interface (e.g., a graphical user interface presented via a user device) so each user can see and hear other participating users.

### SUMMARY

Various aspects of the subject technology relate to systems, methods, and machine-readable media for video-based stream synchronization. Users may access a virtual stage in which a host user can communicate with one or more guest users while being observed by one or more fan users through unique stage experiences for different users with separate, synchronized live streams of individual users being stitched together at client devices. That is, the separate live streams can be arranged in a synchronized layout for each client device according to a mutating server state. One or more application programming interfaces (API) enables updating of all the client devices via pushing a changed server state, which can be reflected by on-screen element updates. In this way, the host user may cause a particular server state to be distributed to all the client devices, such as in real time, in order to enable all client devices to receive a consistent synchronized layout of the separate live streams based on the distributed server state. A user who subscribes to a host's video channel can access the channel to view guest interviews by host while interacting with the interviewee and host, such as asking questions, joining the conversation on stage, taking virtual selfies in high definition, and/or other interactions. For example, a user of one or more of the client devices can be invited on or leave the stage, which can be reflected by the distributed server state.

One aspect of the present disclosure relates to a method for outputting a synchronized arrangement of a plurality of video streams. The method may include selecting a stage status for a subset of the plurality of client devices. The method may include determining, based on the stage status, that a client device of the plurality of client devices is assigned a stage state. The method may include sending, based on the stage status and the stage state being assigned to the client device, a server state to each client device of the plurality of client devices. The method may include determining, based on the server state, a graphical layout including a position and size of each video stream of the plurality of video streams to output to a graphical user interface. The method may include providing, to each client device of the plurality of client devices, instructions to display the synchronized arrangement of the plurality of video streams according to the graphical layout.

Another aspect of the present disclosure relates to a system configured for outputting a synchronized arrangement of a plurality of video streams. The system may include one or more hardware processors configured by machine-readable instructions. The processor(s) may be configured to select a stage status for a subset of the plurality of client devices. The processor(s) may be configured to determine, based on the stage status, that a client device of a plurality of client devices is assigned a stage state. The processor(s) may be configured to send, based on the stage status and the stage state being assigned to the client device, a server state to each client device of the plurality of client devices. The processor(s) may be configured to determine, based on the server state, a graphical layout comprising a position and size of each video stream of the plurality of video streams to output to a graphical user interface. The processor(s) may be configured to provide, to each client device of the plurality of client devices, instructions to display the synchronized arrangement of the plurality of video streams according to the graphical layout.

Another aspect of the present disclosure relates to a non-transient computer-readable storage medium having instructions embodied thereon, the instructions being executable by one or more processors to perform a method for outputting a synchronized arrangement of a plurality of video streams. The method may include selecting a stage status for a subset of the plurality of client devices. The method may include determining, based on the stage status, that a client device of the plurality of client devices is assigned a stage state. The method may include sending, based on the stage status and the stage state being assigned to the client device, a server state to each client device of the plurality of client devices. The method may include determining, based on the server state, a graphical layout including a position and size of each video stream of the plurality of video streams to output to a graphical user interface. The method may include providing, to each client device of the plurality of client devices, instructions to display the synchronized arrangement of the plurality of video streams according to the graphical layout.

Another aspect of the present disclosure relates to a method for outputting a synchronized arrangement of a plurality of video streams. The method may include selecting a stage status for a subset of the plurality of client devices. The method may include determining, based on the stage status, that a client device of the plurality of client devices is assigned a stage state. The method may include sending, based on the stage status and the stage state being assigned to the client device, a new server state to each client device of the plurality of client devices. The method may include determining, based on the server state, a graphical layout including a position and size of each video stream of the plurality of video streams to output to a graphical user interface. The method may include receiving, from a host device, an instruction to set a first video stream corresponding to the client device at a side position of the graphical layout and to set a second video stream corresponding to the another client device at a center position of the graphical layout. The method may include determining, based on the instruction and the new server state, a change to the graphical layout. The method may include providing, to each client device of the plurality of client devices, instructions to display the synchronized arrangement of the plurality of video streams according the change to the graphical layout.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a device operating environment with which aspects of the present disclosure can be implemented.

FIG. 2 is a block diagram of an example computing network of an example content platform for outputting a synchronized arrangement of a plurality of video streams, according to certain aspects of the present disclosure.

FIG. 3 is a block diagram illustrating an example computer system (e.g., representing both client and server) with which aspects of the subject technology can be implemented.

FIG. 4 illustrates an example view of a graphical user interface in which multiple video streams are arranged and synchronized, according to certain aspects of the present disclosure.

FIGS. 5A and 5B illustrate example views of the graphical user interface of FIG. 4 in which an additional fan is added to a stage area, according to certain aspects of the present disclosure.

FIGS. 6A and 6B illustrate example views of the graphical user interface of FIG. 4 in which multiple video streams from different users are outputted and arranged together to simulate a selfie picture experience, according to certain aspects of the present disclosure.

FIGS. 7A and 7B illustrate example views of the graphical user interface of FIG. 4 in which a meet-and-greet experience is converted into a simulated selfie experience, according to certain aspects of the present disclosure.

FIG. 8 is an example flow diagram video-based stream synchronization, according to certain aspects of the present disclosure.

FIG. 9 is a block diagram illustrating an example computer system in which aspects of the present disclosure can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed systems, methods, and machine-readable media address one or more problems in traditional computing platforms for video-based stream synchronization. Existing solutions for providing real time audiovisual communications between remotely located users fail to facilitate user experiences where individual users can join, unjoin, and interact in ways that simulate real world interactions and experiences.

Implementations described herein address the aforementioned shortcomings and other shortcomings by providing a virtual stage in which a host user can communicate with one or more fan users while being observed by one or more guest users. In exemplary implementations, individual client devices may receive multiple video streams from different users and a stage state which determines how the multiple video streams should be arranged at the individual client device. That is, instead of multiple video streams being combined at a server and transmitted to the multiple client devices, the individual client devices assemble the multiple video streams based on the stage state, thus enabling individual client device to present the multiple video streams in manner unique from other client devices receiving the multiple video streams. Different fans can join and unjoin a stage area. Once in the stage area, users can speak together and interact to simulate real world experiences such as group selfies.

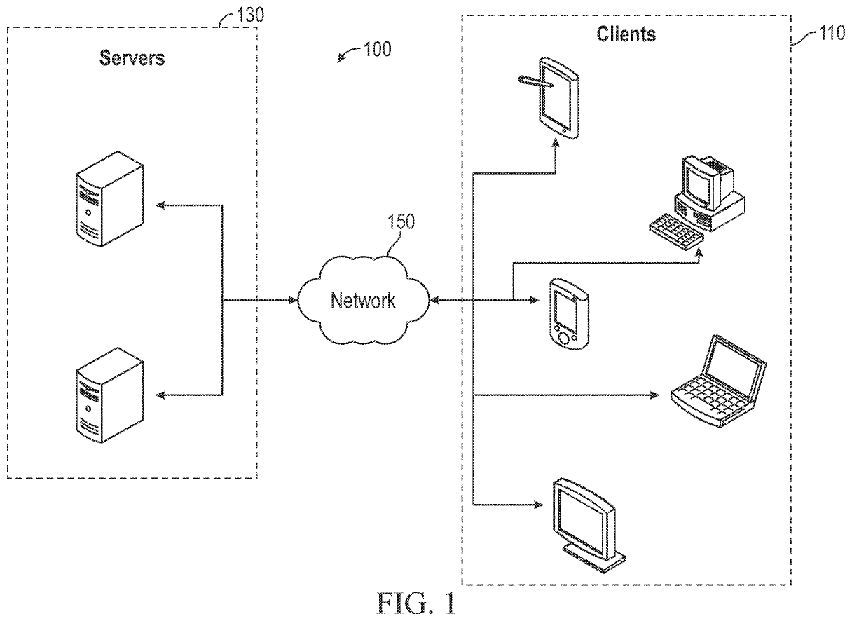

FIG. 1 is a block diagram of a device operating environment with which aspects of the present disclosure can be implemented. FIG. 1 illustrates an exemplary network architecture 100 to provide for outputting a synchronized arrangement of a plurality of video streams, according to some embodiments. The network architecture 100 of FIG. 1 includes one or more client devices 110 and one or more servers 130 which are communicatively coupled through the network 150. The network 150 may include a wired network (e.g., via fiber optic or copper wire, telephone lines, and the like) or wireless network (e.g., a cellular network, radio-frequency (RF) network, Wi-Fi, Bluetooth, and the like). The client devices 110 may be any one of a mobile device, a laptop, a desktop, a tablet (e.g., palm or pad) device, a television, a display device, and/or the like. The client devices 110 can be controlled by a user to provide and/or facilitate video-based stream synchronization, such as via the mechanisms described herein. Multiple client devices 110 may have access to the content platform hosted by the servers 130 via an online or offline connection, such as a wireless connection, wired connection, ad hoc connection, mobile connection, satellite connection, and/or the like. Each of the servers 130 may be a computing device such as part of a cloud computing server including one or more desktop computers or panels mounted on racks, and/or the like. The panels may include processing boards and also switchboards, routers, and other network devices.

The servers 130 may comprise memory to determine, host, manage, analyze, and/or display one or more of video streams, video stream metadata, user information, stage state information, server state information, and/or other information. The computing devices of the servers 130 can comprise processors to execute various algorithms and/or modules for outputting a synchronized arrangement of a plurality of video streams. For example, the computing devices of the servers 130 may select a stage status for a subset of the plurality of client devices. The computing devices of the servers 130 may determine, based on the stage status, that a client device of the plurality of client devices is assigned a stage state. The computing devices of the servers 130 may send, based on the stage status and the stage state being assigned to the client device, a server state to each client device of the plurality of client devices. The computing devices of the servers 130 may determine, based on the server state, a graphical layout comprising a position and size of each video stream of the plurality of video streams to output to a graphical user interface. The computing devices of the servers 130 may provide, to each client device of the plurality of client devices, instructions to display the synchronized arrangement of the plurality of video streams according to the graphical layout. Although video-based stream synchronization is described as being performed separately by the servers 130, processes for outputting a synchronized arrangement of a plurality of video streams could be performed by the same computing component, such as all being performed on each of the client devices 110 or having the servers 130 and client devices 110 being part of the same computing system.

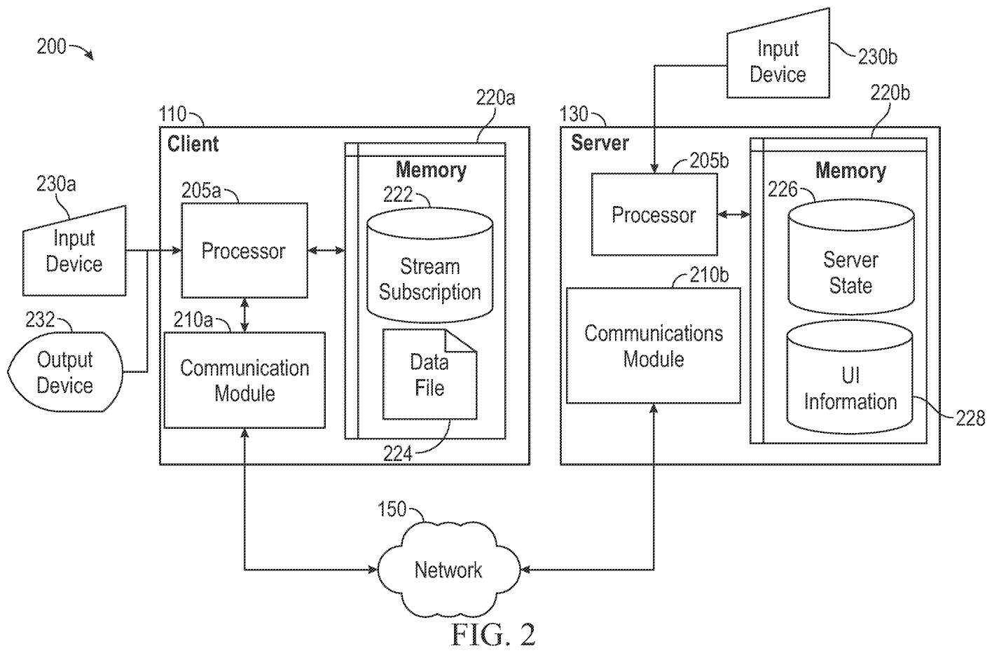

FIG. 2 is a block diagram of an example computing network 200 of an example content platform for outputting a synchronized arrangement of a plurality of video streams, according to certain aspects of the present disclosure. FIG. 2 illustrates a client device (of one or more client devices) 110 and a server (of one or more servers) 130 of the example computing network 200 for use in the network architecture of FIG. 1, according to some embodiments. Each of the one or more client devices 110 and the one or more servers 130 may access each other and other devices in the network 150 via corresponding communications modules 210a-210b. The communications modules 210a-210b may each include radio hardware and software such as RF antennas, analog circuitry, digital to analog conversion circuits, digital signal processing circuitry, and/or the like. The client device 110 and server 130 depicted in FIGS. 1-2 may each include a processor 205a-205b and memory 110a-110b, respectively.

Generally, the client device 110 and the server 130 comprise computing devices including at least: the memory 220a-220b storing instructions and processors 205a-205b configured to execute the instructions to perform, at least partially, one or more steps as described in methods disclosed herein. For example, the memory 220a of the client device 110 may be used to gain access to a browser, application, or device component corresponding to the server state 226 and/or UI information 228 hosted by the server 130. The client device 110 may be used by a user, such as to access synchronized video streams associated with different users, such as via a graphical user interface (GUI) screen rendered on the client device 110.

The synchronized video streams can be in a synchronized position on a display or output screen based on a server state from the server 130 pushed (e.g., via a host device) to multiple client devices 110. As an example, all of the client devices 1110 can subscribe to a content show hosted by the server 130. For example, the client device 110 may be coupled to at least one input device 230a and output device 232 accessible by the user (e.g., for user input and output perceivable by the user). The input device 230a can include a mouse, keyboard, a pointer, a stylus, a touchscreen display, microphone, voice recognition software, graphical user interface (GUI), and/or the like. The output device 232 can include a display (e.g., the same touchscreen display as the input device), a speaker, an alarm, and the like. The position or graphical layout of the synchronized video streams on the display can be determined on client logic of the client devices 110 which uses the received server state from the server 130 to determine how to display the synchronized video streams. As an example, the synchronized video streams can include video streams corresponding to a celebrity interviewed by a host (via a host device) with guests (e.g., fans using the client devices 110).

As an example, the user may interact with a specific channel to which the user is subscribed via the input device 230a, such as asking questions, joining the conversation on stage, taking virtual selfies in high definition, and/or other interactions, and/or the like or other user desired operations. That is, the user can use mechanisms for interactions with a received synchronized arrangement of a plurality of video streams for purposes such as answering trivia questions, playing games, buying merchandise, engaging with a host user and/or one or more guest users, and/or the like. The client device 110 may output a synchronized arrangement of the plurality of video streams based on receiving a change or mutation in server state from the server 130, such as receiving an indication of the respective positions of multiple live video streams of users (e.g., a host user, one or more guest users, and/or one or more fan users) and/or the like. The client device 110 may execute a chat software development kit such as based on Agora Real-time Video Chat SDK, which may enable the user of the client device 110 to talk to others subscribing to the synchronized video streams.

As an example, the server state may indicate that a video stream from a particular client device 110 that has been invited on stage should be positioned in a central position with a video stream from a host client device 110 and with the video streams from the remaining subscribing client devices 110 positioned at a side position. The particular client device 110 invited onstage may enable the corresponding user to experience being “onstage” with a celebrity, for example. The remaining client devices 110 may output the synchronized video streams via received pushed server state, with the video stream of the particular client device 110 being highlighted. The host client device 110 can control changes in the server state being pushed so that particular client device 110 stays invited onstage or one or more user of other client devices 110 may be invited onstage instead. In general, the host client device 110 may have options to set or alter a graphical layout or arrangement of the synchronized video streams which can be pushed to all of the multiple client devices 110 via corresponding client logic based on the pushed server state. The input device 230a may be used by a user to select video stream settings, user experiences (e.g., virtual selfie experience), user questions or answers, and/or other user selections. The output device 232 may be used to provide for presentation to the user of an interactive graphical user interfaces displaying multiple live video streams of users, which may have a graphical layout for all subscribing client devices based on a stage state pushed by the server 130, which can function as a central server.

The processor 205a of the client device 110 may be used to operate the client device 110, such as to execute applications and functions thereof rendered on the client device 110. The applications can include an application implementing client logic for video-based stream synchronization. As an example, the client logic can implement settings or changes indicated by the pushed server state, such as based on a reactive user interface framework (e.g., based on VueJS) that enables state changes to be automatically reflected into on-screen element updates. The current status of and changes to the server can be communicated to the client devices 110 via a query or mutation API and/or subscriptions via WebSockets, for example. The query API may enable the client devices 110 to issue commands to the server 130 while the subscriptions may enable push updates to be received by each client device 110 based on a server event from the server 130. In this way, the user can use the input device 230a (e.g., to send user inputs) to cause the processor 205a to execute machine executable instructions for outputting the received synchronized arrangement of a plurality of video streams, as well as select, manage, and/or perform other functions associated with video-based stream synchronization. For example, the user may ask questions, join a featured conversation, take virtual group selfies in high definition, and/or other interactions.

The stream subscription information stored in the database 222 of the memory 220a can include application settings, files, and data specific to individual users of the client device(s) 110, such as subscription information, identities of subscribed video channels, video channel information, and/or the like corresponding to user accounts. The stream subscription information in the database 222 can be data indicative of user specific activity, such as questions asked, conversations joined, virtual group selfies taken, and/or other interactions. For example, the database 222 may included questions submitted by the users of the client device(s) 110. The user submitted questions may be formed into a queue, which can be managed by the host client device 110, such as according to a stage layout associated with a server state set by the host client device 110. The stream subscription information stored in the database 222 may enable users (e.g., fans) to select which synchronized video streams they want to subscribe to so as to decide which celebrities that the fans want to meet, for example.

The data file 224 stored in the memory 220a can include application settings, files, and data specific to the associated user of the client device 110, such as stage state information, video stream information, user profile information, user preferences information, historical utilization information, user contacts information, celebrity merchandise purchase information, and/or other information, and/or the like corresponding to the associated user's account. The data files 224 can contain data indicative of user specific activity, such as questions asked, conversations joined, virtual group selfies taken, and/or other interactions. The data files 224 can be used to enable client device(s) 110 to download selfies, such as virtual selfies taken by one or more fans with one or more celebrities. The data files 224 may also include information to deliver and/or otherwise implement purchases of celebrity merchandise made by the client device(s) 110.

The processor 205b of the server 130 may be used to operate the server 130, such as to execute applications and functions thereof rendered on the server 130. The applications can include an application corresponding to video-based stream synchronization. In this way, the processor 205b may execute machine executable instructions for causing output of a synchronized arrangement of a plurality of video streams, as well as to select, manage, and/or perform other functions associated with video-based stream synchronization, such as providing a chat function, a selfie function, and/or the like. For example, the processor 205b can trigger taking a simultaneous digital selfie with fans and celebrities using one or more client devices 110. For the simultaneous selfie, each fan and/or celebrity involved in a selfie being taken may be separately (or together for some subset of the fans/celebrities) photographed via a camera of the corresponding client device 110, which can be combined into a aggregate digital selfie that can be downloaded (e.g., by the fans). For example, the processor 205b may be configured to change a stage state, change a server state, cause broadcast of state information to client devices, process video streams, and/or other functions. The processor 205b may cause a server state status or an update (e.g., mutation) to server state to be pushed to the client device 110.

Server state information can be stored in the database 226 stored in memory 220b of the server 130. The database 226 can include host device preferences and selections as well as current server state and changes to server state. The host device preferences and selections can included an ability for the host client device 110 to decide to bring a fan onstage, which can cause the server state to mutate to reflect that the client device 110 corresponding to the fan being brought onstage should have its video stream change position for the synchronized video streams. The host device can also select to change other displays setting such as a theme (e.g., graphical theme) that can include a trivia graphical theme, a merchandise graphical theme, and/or the like. The graphical layout and/or general manner that all the streams of the video streams should be assembled can be determined based on the current server state and changes to server state which are stored in the database 226. The server state 226 can contain data indicative of user specific activity, such as user selections, user preferences, user interactions, past activities, and/or other interactions.

The UI information stored in the database 228 of the memory 220b of the server 130 can include application settings, files, and data specific to individual users of the client device(s) 110, such as user preferences, arrangements of video streams within a client device interface, identity of video streams to be included within a client device interface, and/or the like corresponding to user accounts. The UI information in the database 228 can contain data indicative of user interface (UI) settings, such as trivia based UIs, selfie based UIs, game based UIs, selfie based UIs, and/or the like. The particular type of UI being selected from the UI options stored in the database 228 can be determined based on input received by the host client device 110. In this way, the selected type of UI can be formed based on UI information retrieved from the database 228 and pushed to all of the client devices 110 via server state, which can enable the client devices 110 to assemble the synchronized video streams in a manner that is according to the selected type of UI.

Although the above description describes certain functions being performed by the processor 205a of the client device 110 and other certain functions being performed by the processor 205b of the server 130, all of the functions described herein can be performed by the client device 110 and/or the server 130 in some other alternative division of labor. That is, the processors 205a, 205b could perform more or less of the functions (e.g., portions of the machine learning algorithm and/or image processing) described above. In some embodiments, some or part of the client device 110 can be co-located with the server 130. That is, the server 130 can be remote from or both the client device 110 and the server 130 can be part of the same larger computing system, network, or architecture.

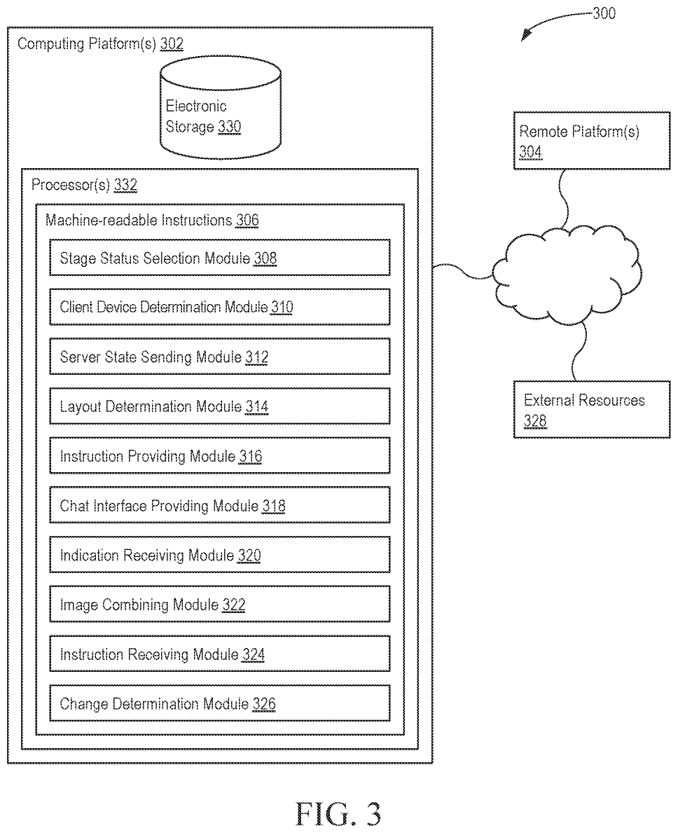

FIG. 3 is a block diagram illustrating an example computer system 300 (e.g., representing both client and server, server alone, one computing device, etc.) with which aspects of the subject technology can be implemented. The system 300 may be configured for outputting a synchronized arrangement of a plurality of video streams, according to certain aspects of the disclosure. In some implementations, individual ones of the plurality of video streams may include video data collected via camera devices of the plurality of client devices. By way of non-limiting example, outputting the synchronized arrangement of the plurality of video streams may include providing, for presentation via a client device, a graphical user interface showing multiple live streams of a host, one or more fans, and/or one or more guests. In some implementations, system 300 may include one or more computing platforms 302. The computing platform(s) 302 can correspond to one or more components of network architecture 100 in FIG. 1 and/or computing network 200 in FIG. 3 including client(s) 110, server(s) 130, and/or components thereof.

The computing platform(s) 302 may be configured to communicate with one or more remote platforms 304 according to a client/server architecture, a peer-to-peer architecture, and/or other architectures via a network 150, such as for outputting a synchronized arrangement of a plurality of video streams such as described herein. The remote platform(s) 304 may be configured to communicate with other remote platforms via computing platform(s) 302 and/or according to a client/server architecture, a peer-to-peer architecture, and/or other architectures.

The computing platform(s) 302 may be configured by machine-readable instructions 306. The machine-readable instructions 306 may be executed by the computing platform(s) 302 to implement one or more instruction modules. The instruction modules may include computer program modules. The instruction modules may include one or more of a stage status selection module 308, a client device determination module 310, a server state sending module 312, a layout determination module 314, an instruction providing module 316, a chat interface providing module 318, an indication receiving module 320, an image combining module 322, an instruction receiving module 324, a change determination module 326, and/or other instruction modules, and/or the like.

The stage status selection module 308 may select a stage status for a subset of the plurality of client devices. The stage status may include a description of content presented and arranged in the subset of the plurality of client devices. The stage status may also include a server state indicative of how the plurality of video streams should be arranged for simultaneous sending to multiple client devices, which can be part of the remote platform(s) 304. As an example, the stage status selection module 308 may determine a server state to be sent or pushed to the remote platform(s) 304 so that all client devices of the remote platform(s) 304 receive a synchronized server state. The synchronized server state can be used to indicate which fans and/or guests are “on stage” with a host. Being onstage can mean that the video stream of a fan is position and displayed close to the video stream of a host and/or guest. For example, the synchronized server state can indicate that the video streams of a the host, guest, and fan invited on stage are positioned prominently on each screen of each client device of the remote platform(s) 304 that received the synchronized server state, such as to model the experience of bringing a fan on stage to meet a celebrity. By way of non-limiting example, the subset of the plurality of client devices may include one or more client devices associated with a host, one or more fans, and/or one or more guests.

Selecting the stage status for the subset of the plurality of client devices may include determining publication of corresponding video streams for the subset of the plurality of client devices that have subscribed to a video channel corresponding to the plurality of video streams. That is, only the client devices the remote platform(s) 304 that subscribe to the video channel or a particular meet and greet session with a guest or celebrity may receive a synchronized arrangement of video streams according to the server stage determined by the stage status selection module 308. The stage status selection module 308 can determine the stage state based receiving a user selection from a host device associated with a host. The host can be a host user corresponding to a host client device of the remote platform(s) 304. The video channel may include a channel available via subscription to users of a social media platform. Being subscribed to the video channel may include having access to the video channel. Determining publication of the corresponding video may stream includes identifying one or more video streams to publish. The published one or more video streams may be in high definition, low definition, or any other suitable stream/video quality.

The client device determination module 310 may determine, based on the stage status, that a client device of the plurality of client devices of the remote platform(s) 304 is assigned a stage state. Based on which stage state is assigned, the client device determination module 310 may determine a stream parameter, such as an audio parameter. For example, if the client device determination module 310 determines that the client device has been invited on stage, the audio of the client device's video stream may be enabled. On the other hand, if the client device determination module 310 determines that the client device has not been invited on stage and is merely an audience member, the audio of the client device's video stream may be muted. The client device determination module 310 may cause the corresponding client device to publish the associated video stream into a video channel with the synchronized arrangement of video streams, such as to subscribe to the meet and greet session. As discussed herein, the video streams can include fan video streams, host video streams, guest video streams, and/or the like. The client device of the plurality of client devices being assigned a stage state can use the assigned stage state as a basis for executing instructions as to what content is presented and arranged within a graphical user interface.

The client device determination module 310 can determine a location for the video stream of the plurality of video streams corresponding to the client device being assigned the stage state. For example, if the corresponding client device is assigned an on stage state then the video stream from a camera of the corresponding device can be output to a center position of the graphical user interface. That is, all of the client devices subscribing to the meet and greet session can receive an indication of the synchronized arrangement of video streams such that client device logic causes all client devices to display the corresponding client device at the center of each display screen. In this way, being assigned the on stage state can simulate an experience of being on stage with a celebrity.

Being assigned the on stage state may cause audio from the video stream of the corresponding device to be audible, such as by outputting sound information corresponding to video information of the corresponding video stream. The audio from the corresponding device that is currently on stage may be distributed to all of the remaining client device participating in the celebrity meet and greet session. If the corresponding client device is assigned an off stage state, then the video stream from a camera of the corresponding device can be output to a center position of the graphical user interface. In this way, being assigned the off stage state can simulate an experience of being in the audience for the celebrity meet and greet session. As such, the determined location for the video stream can be a position of display of the video stream within the graphical user interface presented via a client device. Being assigned the on stage may cause the on stage video stream to be displayed at a larger size than the remaining off stage video streams.

The characteristics of the graphical user interface can also be determined by the client device determination module 310. For example, the characteristics can include a graphical theme such as a game theme, celebrity based theme (e.g., theme based on visual objects related to the celebrity), merchandise theme, trivia theme, interview theme, and/or the like. The characteristics can also include the relative size and position for each video stream of the plurality of video streams. The characteristics generally may define what type of background is used for the graphical user interface, which can be selected and changed by the host device. The characteristics can be determined based on the host device. As an example, the client device determination module 310 can receive, via an input from a host device, a selection of a stage layout. The input from the host device may include user selections received via a graphical user interface presented via the host device.

The selection of the stage layout may include a selection of a predefined stage layout or a modification to a present state layout. For example, the host device can be used by a host to determine what type of celebrity and fan interaction is preferable. As an example, the host can use the host device to select the game theme for a game night type celebrity meet and greet session. The host can cause a change in the graphical layout of the graphical user interface to the stage layout, such as by selecting a different graphical theme, layout, or interface characteristic. The host device can cause the graphical layout to be changed by pushing a mutated server state. For example, the host device can cause the game theme to be changed to the merchandise theme when the celebrity meet and greet session is close to ending. For example, the host device can cause one or more different users/fans to be invited on stage and for the current client device on stage to be moved off stage (e.g., the corresponding user/fan goes back to being an audience member).

The server state sending module 312 may send, based on the stage status and the stage state being assigned to the client device, a server state to each client device of the plurality of client devices. As an example, the server state sending module 312 can be part of a central server that pushes a current server state and mutations (e.g., changes) to the current server state to all of the client devices that are currently subscribed to the celebrity meet and greet session. In some implementations, a given server state may include a stage state stored by the server, which can include states such as on stage, off stage, group stage, etc. As an example, the server state sending module 312 may send an update to server state to cause all of the subscribing client devices to change their layout of the synchronized plurality of streams from a general audience or group setting layout to a celebrity on stage interview layout when it is desirable to allow individual audience members to talk to the celebrity. The change to layout can be implemented by a reactive user interface framework (e.g., VueJS) which enables state changes to be automatically reflected into on-screen element updates, for example. The layout changes simultaneously sent to all of the client devices can implement a show experience with a dynamic stage. Sending the server state may include detecting a selection of a user interface component rendered on the host device such as by receiving an indication of the selection from the host device.

That is, the host can use the host device to control what layout should be selected and pushed to all of the client devices so that the synchronized plurality of streams can be simultaneously or near simultaneously arranged according to the host's selection via client logic. In other words, the server state being received by a given client device may effectuate updating the server state. The updated server state may be communicated to the plurality of client devices in a push update. The server state sending module 312 may send, based on the stage state being assigned to another client device of the plurality of client devices, a new server state. For example, when the stage state being assigned to the another client device means that the fan corresponding to the another client device is being invited on stage and the current fan appearing on stage is moving off stage, the server state sending module 312 can send the new server state to change the arrangement of the plurality of streams so that the correct video streams are on stage and off stage, respectively, and the graphical layout for the streams accords with what is currently occurring in the celebrity meet and great session. The server state sending module 312 can send the new server state via GraphQL mutations or subscriptions, for example.

The layout determination module 314 may determine how all of the plurality of streams should be configured on one page (e.g., the graphical user interface). The determined configuration can be indicated as part of a stage state and/or server state pushed to all of the client devices by the server state sending module 312. For example, the layout determination module 314 can determine, based on the server state, a graphical layout including a position and size of each video stream of the plurality of video streams to output to the graphical user interface. The quantity of the video streams can be two, five, ten, one hundred, or some other suitable number. The layout determination module 314 can determine which live video streams should be displayed and how, such as based on the determined position and size. The position and size of the subset of video streams “appearing on stage” can be displayed more prominently than those “appearing off stage” such as by causing video streams corresponding to an on stage position to occupy a large portion of a each client device's viewport at a central position.

In this way, the layout determination module 314 can cause display of the graphical user interface via each client device according to the layout selected by the host. The host selected layout can include user interface elements which can be part of a layout template and/or selected by the host via input into their host device. For example, the user interface elements may include backgrounds, logos, images, extra stage components, etc. which can be associated with a likeness, appearance, or representation of the celebrity being greeted. The plurality of video streams being arranged into a layout can include at least one fan video stream, host video stream, guest video stream, and/or the like. The fan video stream may correspond to a fan accessing the client device being assigned the server state. The host video stream may correspond to a host accessing the host device. The guest video stream may correspond to a guest accessing a client device. As discussed herein, display of the host video stream and the fan video stream may be prominent in the graphical user interface. Being prominent in the graphical user interface may include occupying an area of the graphical user interface that breaches a threshold area.

The layout determination module 314 can determine a label of the graphical layout, which can be an alphanumeric indication and/or a visual indication associated with the graphical layout. Visual indications include animation or audio effect for the graphical layout, such as a bell or buzzing sound for trivia, a camera shutter sound for taking a selfie, and/or the like. The layout determination module 314 may also include determining a selfie layout for taking a selfie, such as with both the celebrity and fan. As an example, both of the celebrity and fan's corresponding client device can use their camera to independently take their own picture. The independently taken pictures can be combined into a selfie, which can be downloaded via the client device corresponding to the fan. The selfie layout can include options for generating a recording of at least a portion of the graphical user interface. The recording may include an audiovisual data file that is accessible to one or more client devices of the plurality of client devices. By way of non-limiting example, being accessible to a given client device may include being one or more of viewable, sharable, and/or downloadable.

The host device can provide the host with a host user interface to control the layout being selected, the user interface elements being used, the server state being selected, and/or the like. For example, in the host user interface, the host can use the host device to select buttons or menus corresponding to the graphical layout being used to configure all of the plurality of video streams. As an example, the host selection user interface can include hover menus over each of the fans/fan client devices so that the host can bring one or more fans on stage or off stage via a mutated server state. That is, the host device can issue commands to a central or remote server to update server state, such as via GraphQL mutations. This updated server state may reflect which video streams have an on stage status, off stage status, or some other status. The updated server state may also reflect what background, theme, user interface visual elements are configured, selected, and/or display as well as any other visual appearance selections for the graphical layout (e.g., dynamic stage) made by the host. The updates to layout can be sent via the layout determination module 314 to each subscribing client device in order to cause each client device to update the client's local state, such as being sent over a real-time channel over Graph QL subscription. When the local state of each client is update, the stage layout is correspondingly updated according to the visual appearance selections and controls set by the host via the host device.

The instruction providing module 316 may provide, to each client device of the plurality of client devices, instructions to display the synchronized arrangement of the plurality of video streams according to the graphical layout. For example, the instruction providing module 316 may provide instructions to display the synchronized arrangement of the plurality of video streams according to a change in the graphical layout. The change in graphical layout can be caused by the host using the host device to cause an update to the server state, such as based on changing or selecting a theme, visual element, on stage fan, and/or the like. The host device may have render the host interface with controls so that the host can control the meet and greet session, such as to start the meet and greet event, end the event, start taking selfies and change the layout to a selfie format layout/stage, and/or the like. The controls selected/implemented by the host can be pushed to the plurality of client devices so that all client devices subscribing to the meet and greet session can accurately arrange the synchronized plurality of video streams according to the graphical appearance determined by the host via the host device. As discussed herein, the graphical appearance can include custom stages such as the selfie stage for taking downloadable virtual selfies, a question stage for featuring questions from the audience to the users “located” on stage (e.g., featured questions can appear on the graphical interface under the video streams corresponding to on stage to simulate a talk show), a game stage, a shop (e.g., celebrity merchandise) stage, a trivia stage, and/or the like.

The chat interface providing module 318 may provide a chat interface of the graphical layout for receiving textual inputs or user inputs from each client device of the plurality of client devices. For example, the chat interface providing module 318 can implement a chat SDK such as the Agora real-time video chat SDK, which provides an API along with a video chat infrastructure (e.g., webRTC). In this way, the chat interface providing module 318 can provide a mechanism for users (e.g., fans in an audience for the meet and greet session) to submit questions or chat with other users of client devices that are subscribing to the meet and greet session. The chat interface providing module 318 can enable real time communications, such as in real time updating text box to provide the video chat. The users corresponding to video streams that form part of the audience for the meet and greet session can submit questions into a queue via the chat interface providing module 318 The submitted questions can be managed by the host via the host device, such as for a selected question stage layout. As discussed herein, stage layout and other visual features can be implemented by all subscribing client devices based on a server state update such as the host device pushing mutation in server state to the question stage layout.

The indication receiving module 320 may receive, from a host device, an indication to capture a selfie image of a guest (e.g., celebrity) and a fan associated with the client device. For example, the indication receiving module 320 can cause a preview (e.g., via input from the celebrity) such as a few moments for people to compose themselves before the selfie image is captured. The image combining module 322 may combine an image of the fan from the client device and an image of the guest from a guest device to form the selfie image. In this way, virtual selfie images can be taken remotely based on users (e.g., fans, hosts, celebrities etc.) have their own video stream and/or client devices. In particular, the image combining module 322 can combine screen captures taken locally on each client device involved in the selfie being taken (e.g., via a picture or screenshot from each local camera of each client device), such as the computing platform(s) 302 composite the high quality local screenshots into a full selfie that can be downloadable later. In this way, the image combining module 322 can generate higher quality full selfies compared to merely taking a screenshot of the graphical interface with the synchronized plurality of video streams. A subset of or all of the client devices in the participating in the selfie or meet and greet event can download the full selfie after it is generated.

The instruction receiving module 324 may receive, from a host device, an instruction to set a first video stream corresponding to the client device at a side position of the graphical layout and to set a second video stream corresponding to the another client device at a center position of the graphical layout. In general, the instruction receiving module 324 may receive selected stage layouts, selected user interface elements, and other aspects of a visual appearance of a graphical user interface that all client devices should use. All the aspects of the visual can be represented by a server state or mutated server that that can be pushed or sent from the instruction receiving module 324 to all of the relevant subscribing client devices of the remote platform(s) 304. As discussed herein, the selection or changes in server state can be controlled by buttons provide on an interface by the host device to the host.

The change determination module 326 may determine, based on the instruction and the new server state, the change to the graphical layout. The change in the graphical layout may include a change in appearance, a change in functionality, a change in content and/or a change in the arrangement of content. For example, the change in graphical layout can be a change to stage layout, user interface elements, visual appearance, or other functional features. The change can be based on the host selecting or configuring various host buttons or controls via the host device. In this way, the host can manage the meet and greet with celebrities/guests. Timestamps can be used to indicate changes in visual features represented by a newly pushed server state by the computing platform(s) 302 to the remote platform(s) 304. Accordingly, the change determination module 326 can cause changes in stage layout to and from an talk show stage layout, a merchandise shop stage layout, a game show stage layout, a trivia stage layout, and/or the like, for example. Timestamps determined by the change determination module 326 can be used to set recordings or video clips of various portions of the sessions, such as video clips or screen recordings (e.g., including or not including the chat), which can be downloaded by the client devices.

In some implementations, computing platform(s) 302, remote platform(s) 304, and/or external resources 328 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 328 may be operatively linked via some other communication media.

A given remote platform 304 may include one or more processors configured to execute computer program modules. The computer program modules may be configured to enable an expert or user associated with the given remote platform 304 to interface with system 300 and/or external resources 328, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

The external resources 328 may include sources of information outside of the system 300, external entities participating with the system 300, and/or other resources. In some implementations, some or all of the functionality attributed herein to the external resources 328 may be provided by resources included in the system 300.

The computing platform(s) 302 may include electronic storage 330, one or more processors 332, and/or other components. The computing platform(s) 302 may include communication lines, or ports to enable the exchange of information with a network and/or other computing platforms. Illustration of the computing platform(s) 302 in FIG. 3 is not intended to be limiting. The computing platform(s) 302 may include a plurality of hardware, software, and/or firmware components operating together to provide the functionality attributed herein to the computing platform(s) 302. For example, the computing platform(s) 302 may be implemented by a cloud of computing platforms operating together as computing platform(s) 302.

The electronic storage 330 may comprise non-transitory storage media that electronically stores information. The electronic storage media of electronic storage 330 may include one or both of system storage that is provided integrally (i.e., substantially non-removable) with the computing platform(s) 302 and/or removable storage that is removably connectable to the computing platform(s) 302 via, for example, a port (e.g., a USB port, a firewire port, etc.) or a drive (e.g., a disk drive, etc.). The electronic storage 330 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 330 may include one or more virtual storage resources (e.g., cloud storage, a virtual private network, and/or other virtual storage resources). The electronic storage 330 may store software algorithms, information determined by processor(s) 332, information received from computing platform(s) 302, information received from remote platform(s) 304, and/or other information that enables computing platform(s) 302 to function as described herein.

The processor(s) 332 may be configured to provide information processing capabilities in the computing platform(s) 302. As such, the processor(s) 332 may include one or more of a digital processor, an analog processor, a digital circuit designed to process information, an analog circuit designed to process information, a state machine, and/or other mechanisms for electronically processing information. Although the processor(s) 332 is shown in FIG. 3 as a single entity, this is for illustrative purposes only. In some implementations, the processor(s) 332 may include a plurality of processing units. These processing units may be physically located within the same device, or processor(s) 332 may represent processing functionality of a plurality of devices operating in coordination. The processor(s) 332 may be configured to execute modules 308, 310, 312, 314, 316, 318, 320, 322, 324, and/or 326, and/or other modules. The processor(s) 332 may be configured to execute modules 308, 310, 312, 314, 316, 318, 320, 322, 324, and/or 326, and/or other modules by software; hardware; firmware; some combination of software, hardware, and/or firmware; and/or other mechanisms for configuring processing capabilities on the processor(s) 332. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 308, 310, 312, 314, 316, 318, 320, 322, 324, and/or 326 are illustrated in FIG. 3 as being implemented within a single processing unit, in implementations in which the processor(s) 332 includes multiple processing units, one or more of the modules 308, 310, 312, 314, 316, 318, 320, 322, 324, and/or 326 may be implemented remotely from the other modules. The description of the functionality provided by the different the modules 308, 310, 312, 314, 316, 318, 320, 322, 324, and/or 326 described below is for illustrative purposes, and is not intended to be limiting, as any of the modules 308, 310, 312, 314, 316, 318, 320, 322, 324, and/or 326 may provide more or less functionality than is described. For example, one or more of the modules 308, 310, 312, 314, 316, 318, 320, 322, 324, and/or 326 may be eliminated, and some or all of its functionality may be provided by other ones of the modules 308, 310, 312, 314, 316, 318, 320, 322, 324, and/or 326. As another example, processor(s) 332 may be configured to execute one or more additional modules that may perform some or all of the functionality attributed below to one of the modules 308, 310, 312, 314, 316, 318, 320, 322, 324, and/or 326.

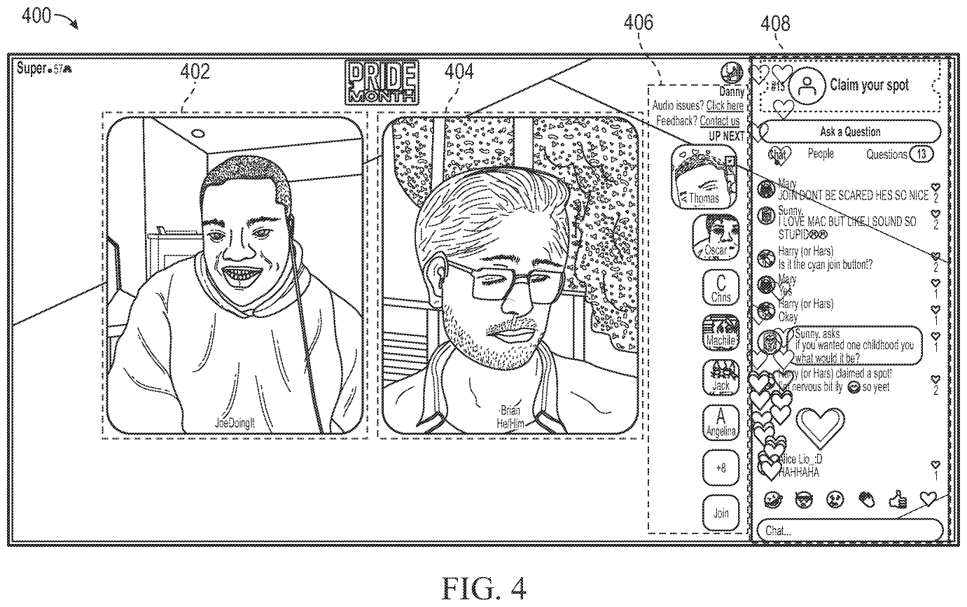

FIG. 4 illustrates an example view 400 of a graphical user interface in which multiple video streams are arranged and synchronized, according to certain aspects of the present disclosure. The graphical user interface can be selected according to a stage layout, user interface options, and other visual appearance options available to a host operating a host device. For example, the visual appearance can include elements associated with a celebrity brand, sponsorship, and/or the like. The visual appearance selected by the host can be represented by a server state which can be pushed to multiple client devices subscribing to a guest (e.g., celebrity) meet and greet event represented by the multiple video streams. The host specified server state can be broadcast in real time via web socket to the multiple client devices such that each client device updates its own state, such as via javascript to assemble the multiple video streams according to a synchronized arrangement of streams specified by the server state. The view 400 of the graphical user interface can show a talk show layout, for example. Various features of the talk show layout can only be accessed after payment. For example, payment can be made to enter a meeting queue (e.g., to “go on stage” with the celebrity), payment can be made to ask the celebrity questions, payment can be a requirement to enter the meet and greet event, merchandise can be purchased from an online store, and/or the like.

As shown in FIG. 4, the view 400 includes a guest area 402, a host area 404, a fan area 406, a chat area 408, and/or other components. The guest area 402 may include display of a guest video stream originating at a camera device of a guest user client device. For example, the guest video stream can show a celebrity who is the subject of the meet and greet session. The host area 404 may include display of a host video stream originating at a camera device of a host user client device. For example, the host video stream can show a host who manages an encounter or event between fans of the celebrity with the celebrity. According to some implementations, the guest area 402 and host area 404 occupy a “stage” of the graphical user interface shown in view 400. The stage of the view 400 can model or simulate the effect of physical stages during in person speaking events, for example. One or more various video streams can be positioned prominently in the graphical user interface to reflect that are “located on stage.” As an example, the video streams that are on stage can be located in a central position and can have a larger size than other streams and other visual elements of the graphical user interface.

As seen in the view 400, the guest area 402 and host area 404 include the guest video stream and host video stream in a prominent central position and can be labeled by the respective names of the shown guest and host. The stage layout represented by the view 400 can be a default feel and greet stage state indicated by a server state pushed to each of the multiple client devices. For example, the stage state can be represented by a data structure comprising a name that describes the overall functionality of the stage and a list of stage slots (e.g., object having a name property for the role of guest, host, fan, screen, etc. as well as a user identification property uniquely identifying the corresponding user). As an example, the host can cause the stage state to mutate via a pushed update to server state to animate a transition from the default stage to the meet and greet stage where one or more fans are invited on stage via having their corresponding video streams displayed prominently in the central position of the graphical user interface.

The remaining fans may have the video streams from their corresponding client devices displayed in the fan area 406 so as to form an audience for the meet and greet stage. The fan area 406 may include display of multiple fan video streams originating at camera devices of individual fan user client devices. Fan users shown in the fan area 406 may be allowed to listen to and watch the host user and guest user(s), but not speak in their conversation. In some implementations, fan users may “join the stage” to become a guest user and join in an active, real-time conversation with the host user and other guest users. The chat area 408 may include a chat interface configured to facilitate textual communications between users of client devices as indicated by the graphical user interface shown in view 400. Users may provide questions via chat area 408, which can be submitted to a queue for example. The chat area 408 can be used to for fans that are part of the audience to talk with each other; that is, the fans operating client devices having video streams that are not currently in an on stage status can be off stage and part of the “off stage audience.” The client devices that subscribed to the meet and greet session can also select reactions, such as emojis, animated effects (e.g., cascading hearts), and other visual effects that reflect an emotional or other type of reaction to an occurrence during the session, such as something the celebrity says during the session.

In general, the view 400 can include special animated effects such as sparks or flashes for the guest celebrity when their video stream first appears on the graphical user interface. For example, for a talent show stage layout, the host device can send the server state to cause all client devices to display confetti effects and music in the background as part of visual and/or animated effects to welcome the celebrity guest. For example, for a selfie stage layout, rounded corners, shadows and borders can be altered in preparation for taking the selfie. As an example, after a countdown, the entire graphical user interface can flash white for a brief period of time to imitate a fake flash. The selfies can be attached or saved to user account profile, which can be displayed on the graphical user interface when a particular user logs into their corresponding account profile, for example. The corresponding account profile may store all selfies taken by and all videos/events participated in by the particular user.

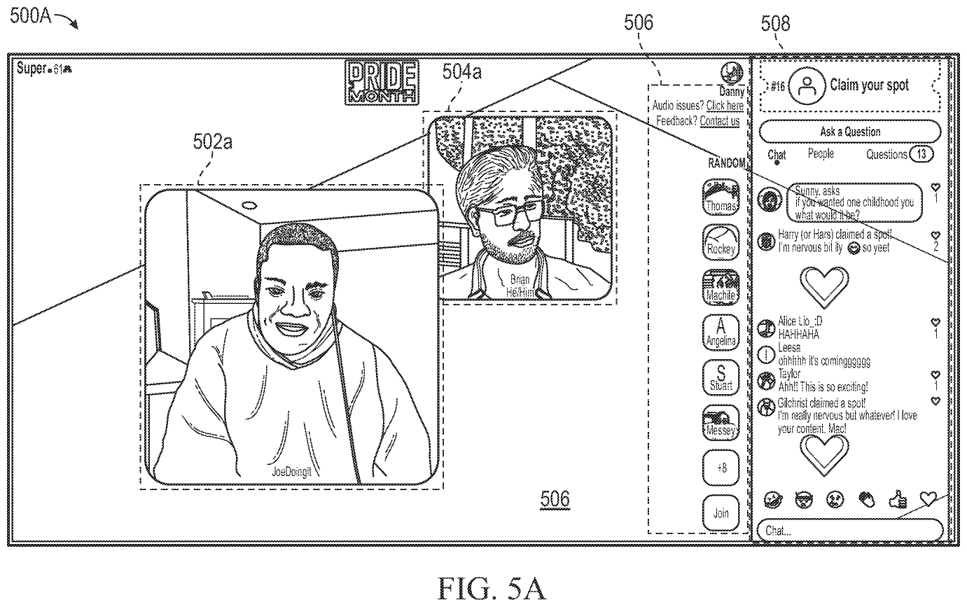

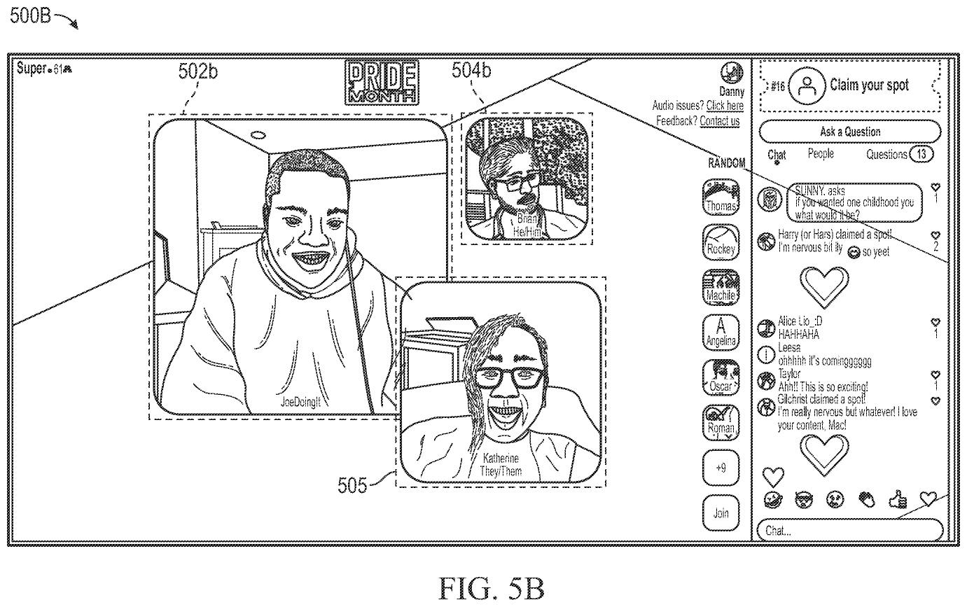

FIGS. 5A and 5B illustrate example views 500a and 500b, respectively, of the graphical user interface of FIG. 4 in which an additional fan is added to a stage area, according to certain aspects of the present disclosure. As shown in FIG. 5A, the view 500a includes a guest area 502a, a host area 504a, a fan area 506a, a chat area 508a, and/or other components. The guest area 502a may be similar to guest area 402 as described in connection with FIG. 4. The guest area 502a may be resized to be larger than the host area 504a, which may emphasize the display of the guest video stream. For example, the guest area 502a can be resized as a host device causes a stage state to change from a default stage layout to a meet and great stage layout. That is, a host can cause a server state to change/mutate to add a new stage slot so that a new fan is added. The new fan can be identified by fan name and user identifier. When the server state changes and is sent to all client devices participating in the meet and greet event, the video stream from the client device of the new fan can be used to fill the new stage slot, as can be seen in FIG. 5B.

The new stage slot can be added relative to the view 500a of FIG. 5A to the view 500b of FIG. 5B. The host area 504a may be similar to host area 404 as described in connection with FIG. 4. The host area 504a may be resized to be smaller than the guest area 502a, which may deemphasize the display of the host video stream. The resizing and change in visual appearance of synchronized video streams (e.g., of the guest/celebrity, fan, and host) can be reflected in the server state change/update sent to all of the client devices. Based on receiving the update of stage state from the pushed server state, each of the client devices can update and rearrange its display screen to update the graphical user interface having the synchronized video streams to include the new fan who has an on stage status. The fan area 506a may be similar to fan area 406 as described in connection with FIG. 4. The fan area 506a may include a fan user who wishes to become a guest user. The chat area 508a may be similar to chat area 408 as described in connection with FIG. 4.

Referring to FIG. 5B, the view 500b may include a guest area 502b, a host area 504b, a new guest area 505, a fan area 506b, a chat area 508b, and/or other components. The guest area 502b may be similar to guest area 402 as described in connection with FIG. 4. The guest area 502b may be resized to be larger than the host area 504b and new guest area 505, which may emphasize the display of the guest video stream. The host area 504b may be similar to host area 404 as described in connection with FIG. 4. The host area 504b may be resized to be smaller than the guest area 502b, which may deemphasize the display of the host video stream and accommodate the new guest area 505. The new guest area 505 may include display of a new guest video stream originating at a camera device of a new guest user client device. A new guest user associated with the new guest area 505 may have previously been a fan user represented in the fan area 506b.

The fan area 506b may be similar to fan area 406 as described in connection with FIG. 4. The new guest user's video stream may be removed from the fan area 506b responsive to the new guest area 505 being presented. The chat area 508b may be similar to chat area 408 as described in connection with FIG. 4. The host device can be used to control camera and audio options for each client device in the fan area 506b or on stage such as the guest area 505b. As an example, the host can use the host device to cause various fans/users of client devices to be muted, featured, etc. The host device may be aware of which client devices have their cameras on based on one or more various client devices sending their client state to a server, such as a central server used to push server state updates to implement the stage state and/or layout selected by the host. For example, the host device can improve the experience of user by determining whether users are in or out of a question or chat queue, have their camera on or off, etc. and using that determination to adjust the meet and greet experience for corresponding users.

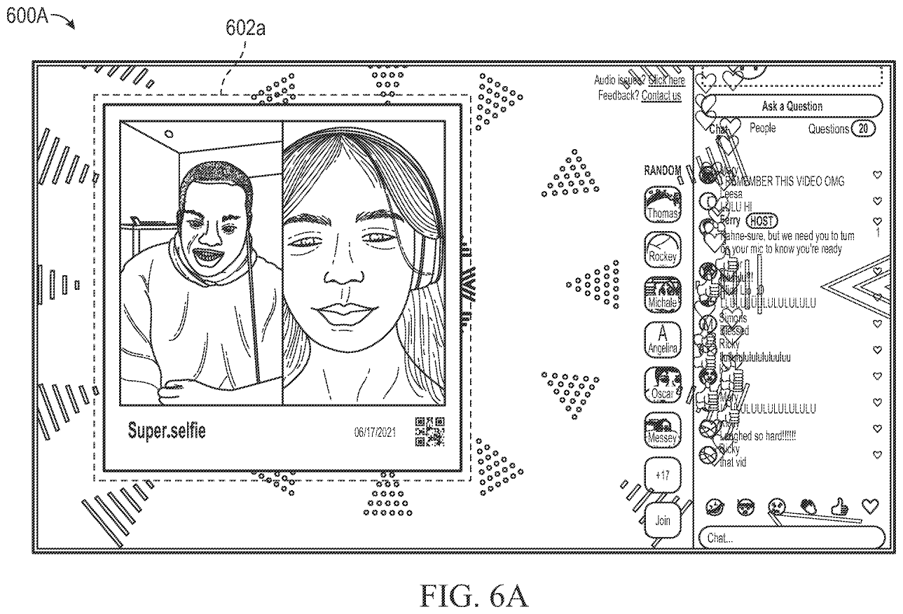

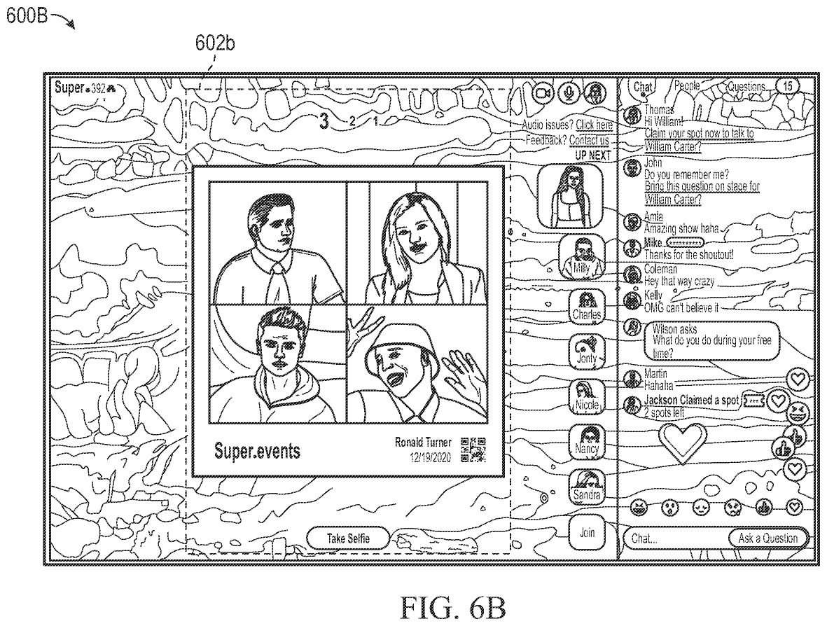

FIGS. 6A and 6B illustrate example views 600a and 600b, respectively, of the graphical user interface of FIG. 4 in which multiple video streams from different users are outputted and arranged together to simulate a selfie picture experience, according to certain aspects of the present disclosure. A “selfie” may include a self-taken photo of oneself alone or with others. As shown in FIG. 6A, the view 600a includes a selfie area 602a and/or other components. The selfie area 602a may include two video streams (e.g., associated with a guest and a fan) arranged together to simulate a real-world group selfie experience. A real-world group selfie experience may include multiple people grouping together an taking a picture of themselves. As shown in FIG. 6B, the view 600b includes a selfie area 602b and/or other components. The selfie area 602b may include four video streams (e.g., associated with a guest and three fans) arranged together to simulate a real-world group selfie experience. In some implementations, users may download full-resolution or high-resolution versions of selfies from the server (as opposed to relatively low-resolution screenshots from client devices).

As an example, the view 600a may illustrate that a full selfie comprising images or pictures individually taken by client devices that have been combined together. The selfies and video clips from a meet and great session or other event that users have participated in can be downloaded by users as digital souvenirs. For example, the digital souvenirs can be sold to the users. A host or celebrity can have an option to preview pictures or screen captures being taken prior to creation of the full selfie. The host or celebrity can push a button on their corresponding client device to cause capture of the full selfie. Additionally, the host or celebrity can have the option of starting a countdown prior to initiation of the selfie pictures or screen captures so that participants in the selfies can have some time to compose themselves for the picture.

The countdown can be caused by the host device sending a mutated server state that causes client devices included in the picture to rearrange their display within a picture frame and other characteristics of a selfie layout. When all client devices that are involved have their displays in a selfie layout, the host device can cause the countdown to start and capture a photo of a selfie canvas. All client devices (even for fans that are not involved in the selfie) can enable their corresponding users to view the countdown and the fun of the selfie experience due to the shared dynamic stage implemented by pushing server state updates simultaneously to all client devices so that all client devices can synchronously rearrange their displays and video streams according to the manner prescribed by the host device. As can be seen in the views 600a and 600b, more than one celebrity and/or fan can be on stage and part of a full selfie. All of the celebrities and/or fans can be combined into one or more full selfies, which can be determined according to settings decided by one or more users of the client devices.

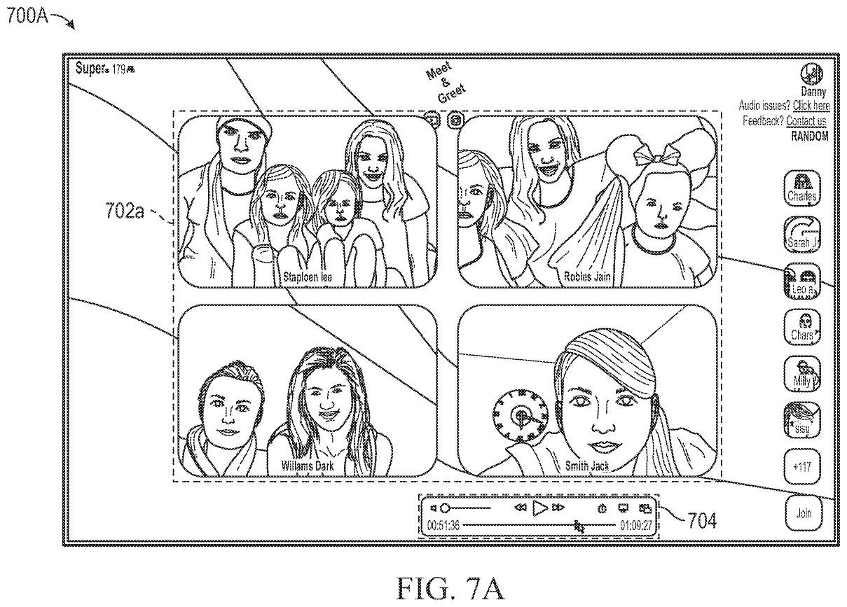

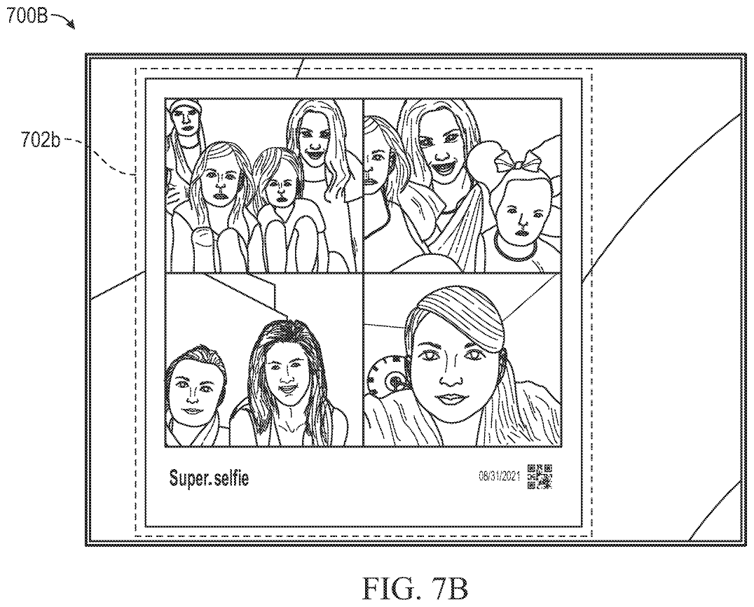

FIGS. 7A and 7B illustrate example views 700a and 700b, respectively, of the graphical user interface of FIG. 4 in which a meet-and-greet experience is converted into a simulated selfie experience, according to certain aspects of the present disclosure. As shown in FIG. 7A, the view 700a includes meet-and-greet area 702a, media controls 704, and/or other components. The meet-and-greet area 702a may include display of multiple user video streams originating at camera devices of individual user client devices. The media controls 704 may include user-selectable controls to select, play, pause, stop, speed up, slow down, and/or otherwise control playback of media files. Examples of media files may include one or more of visual data, video streams, audio data, audio streams, and/or other media. As shown in FIG. 7B, the view 700b includes selfie area 702b and/or other components. The selfie area 702b may include two or more video streams (e.g., associated with two or more users) arranged together to simulate a real-world group selfie experience, such as described in connection with FIG. 6. In some implementations, meet-and-greet area 702a may morph into selfie area 702b responsive to a user selection being received through view 700a in FIG. 7A. As discussed herein, the layouts for the example views 700a-700b or other views described herein can be controlled, selected, or changed according to stage states and/or server states, such as determined by a host device.

The different layouts can have different visual appearances, layouts, and other visual elements that are used for client devices to assemble in that host device selected manner according to individual client device logic. The client devices can arrange the synchronized video streams of the meet-and-greet experience according to the received stage state and/or server state information. Moreover, as seen in the views 700a-700b, when more than one fan or celebrity is “located on stage” the server state can indicate a stage status that has an additional fan stage slot. This additional fan stage slot can cause another fan's video stream from their corresponding client device to be displayed prominently “on stage” in the graphical user interface layout sent to all of the client devices via the server state being sent. In this way, various different synchronized arrangements of video streams can be configured and indicated by server state being pushed to all client devices so that all client devices assemble and output the streams to corresponding display screens in the same manner according to the configured video stream arrangement.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

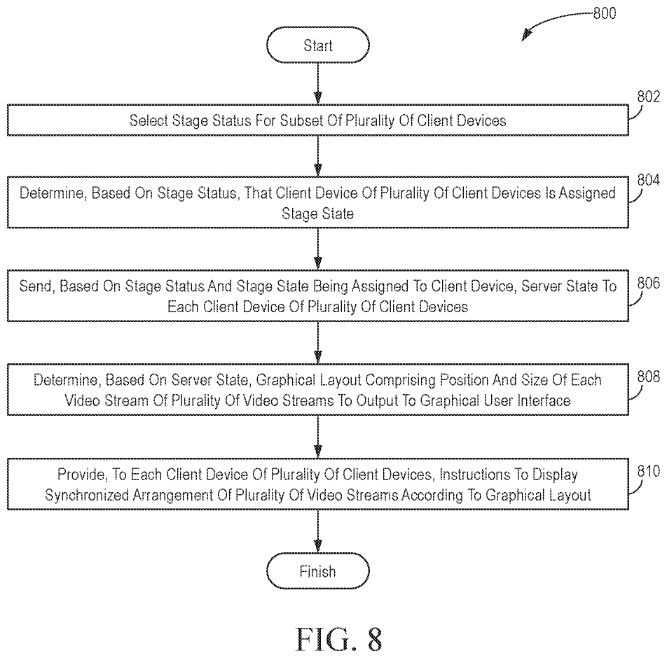

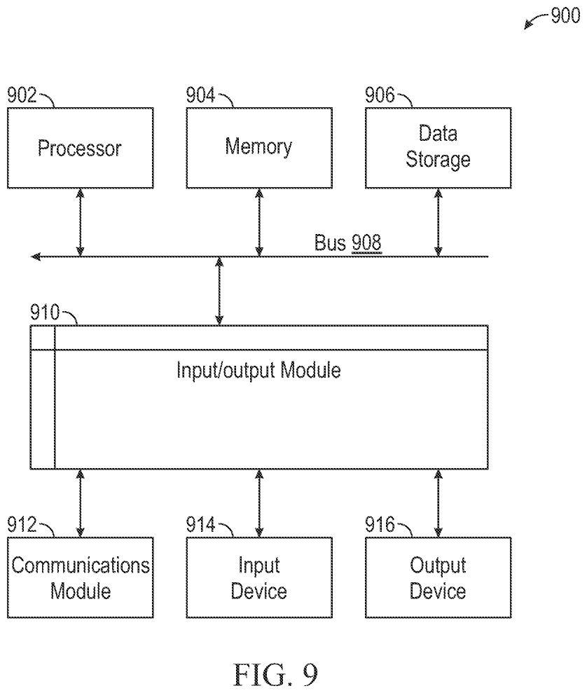

FIG. 8 illustrates an example flow diagram (e.g., process 800) for video-based stream synchronization, according to certain aspects of the disclosure. For explanatory purposes, the example process 800 is described herein with reference to one or more of the figures above. Further for explanatory purposes, the blocks of the example process 800 are described herein as occurring in serial, or linearly. However, multiple instances of the example process 800 may occur in parallel, overlapping in time, almost simultaneously, or in a different order from the order illustrated in method 800. In addition, the blocks of the example process 800 need not be performed in the order shown and/or one or more of the blocks of the example process 800 need not be performed. For purposes of explanation of the subject technology, the process 800 will be discussed in reference to one or more figures above. As an example, the process 800 may be performed at least partially by or via the exemplary network architecture 100 in FIG. 1, the example computing network 200 in FIG. 2, the example computer system 300 in FIG. 3, or the example computer system 900 in FIG. 9 described below. Accordingly, at least some of the steps in process 800 may be performed by a processor executing commands stored in the example computing platform(s) 302, for example. The example process 800 may be for outputting a synchronized arrangement of a plurality of video streams.

At step 802, the process 800 may include selecting a stage status for a subset of the plurality of client devices. Step 802 may be performed by one or more hardware processors configured by machine-readable instructions including a module that is the same as or similar to stage status selection module 308, in accordance with one or more implementations. According to an aspect, selecting the stage status for the subset of the plurality of client devices comprises determining publication of corresponding video streams for the subset of the plurality of client devices that have subscribed to a video channel corresponding to the plurality of video streams.

At step 804, the process 800 may include determining, based on the stage status, that a client device of the plurality of client devices is assigned a stage state. Step 804 may be performed by one or more hardware processors configured by machine-readable instructions including a module that is the same as or similar to client device determination module 310, in accordance with one or more implementations. According to an aspect, determining the client device is assigned the stage state comprises determining a location for a video stream of the plurality of video streams corresponding to the client device being assigned the stage state, receiving audio from the video stream, outputting the audio from the video stream to each client device of the plurality of client devices. According to an aspect, determining the client device is assigned the stage state comprises receiving, via an input from a host device, a selection of a stage layout and determining, based on the input from the host device, a change in the graphical layout of the graphical user interface to the stage layout.

At step 806, the process 800 may include sending, based on the stage status and the stage state being assigned to the client device, a server state to each client device of the plurality of client devices. Step 806 may be performed by one or more hardware processors configured by machine-readable instructions including a module that is the same as or similar to server state sending module 312, in accordance with one or more implementations. According to an aspect, sending the server state comprises detecting a selection of a user interface component rendered on a host device.

At step 808, the process 800 may include determining, based on the server state, a graphical layout including a position and size of each video stream of the plurality of video streams to output to a graphical user interface. Step 808 may be performed by one or more hardware processors configured by machine-readable instructions including a module that is the same as or similar to layout determination module 314, in accordance with one or more implementations. According to an aspect, determining the graphical layout comprises determining the position and size of at least one of: a fan video stream, a host video stream, or a guest video stream, wherein the fan video stream corresponds to a fan accessing the client device being assigned the server state. According to an aspect, determining the graphical layout comprises determining a label of the graphical layout, generating an animation or audio effect for the graphical layout, and generating a recording of at least a portion of the graphical user interface.

At step 810, the process 800 may include providing, to each client device of the plurality of client devices, instructions to display the synchronized arrangement of the plurality of video streams according to the graphical layout. Step 810 may be performed by one or more hardware processors configured by machine-readable instructions including a module that is the same as or similar to instruction providing module 316, in accordance with one or more implementations.

According to an aspect, the process 800 may further include providing a chat interface of the graphical layout for receiving textual inputs or user inputs from each client device of the plurality of client devices.

According to an aspect, the process 800 may further include receiving, from a host device, an indication to capture a selfie image of a guest and a fan associated with the client device. According to an aspect, the process 800 may further include combining an image of the fan from the client device and an image of the guest from a guest device to form the selfie image.

According to an aspect, the process 800 may further include sending, based on the stage state being assigned to another client device of the plurality of client devices, a new server state. According to an aspect, the process 800 may further include receiving, from a host device, an instruction to set a first video stream corresponding to the client device at a side position of the graphical layout and to set a second video stream corresponding to the another client device at a center position of the graphical layout. According to an aspect, the process 800 may further include determining, based on the instruction and the new server state, a change to the graphical layout. According to an aspect, the process 800 may further include providing, to each client device of the plurality of client devices, instructions to display the synchronized arrangement of the plurality of video streams according to the change to the graphical layout.

FIG. 9 is a block diagram illustrating an exemplary computer system 900 with which aspects of the present disclosure can be implemented. In certain aspects, the computer system 900 may be implemented using hardware or a combination of software and hardware, either in a dedicated server, integrated into another entity, or distributed across multiple entities.

The computer system 900 includes a bus 608 or other communication mechanism for communicating information, and a processor 902 (e.g., a CPU, GPU, etc.) coupled with bus 608 for processing information. By way of example, the computer system 900 may be implemented with one or more processors 902. The processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 900 can include, in addition to hardware, code that creates an execution environment for the computer program in question, for example, code that constitutes processor firmware, a protocol stack, a database management system, an operating system, or a combination of one or more of them stored in an included memory 604 (e.g., memory 220a-220b), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to the bus 608 for storing information and instructions to be executed by processor 902. The processor 902 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as a LCD (liquid crystal display) monitor, for displaying information to the user.

According to one aspect of the present disclosure, the example network architecture 100 in FIG. 1, the example computing network 200 in FIG. 2, and/or the example computer system 300 in FIG. 3 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 900 can include clients and servers. A client and server are generally remote from each other and typically interact through a communication network. The relationship of client and server arises by virtue of computer programs running on the respective computers and having a client-server relationship to each other. The computer system 900 can be, for example, and without limitation, a desktop computer, laptop computer, or tablet computer. The computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to the processor 902 for execution. Such a medium may take many forms, including, but not limited to, non-volatile media, volatile media, and transmission media. Non-volatile media include, for example, optical or magnetic disks, such as the data storage device 906. Volatile media include dynamic memory, such as the memory 904. Transmission media include coaxial cables, copper wire, and fiber optics, including the wires that comprise the bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for outputting a synchronized arrangement of a plurality of video streams, the method comprising:
selecting a stage status for a subset of the plurality of client devices;
determining, based on the stage status, that a client device of a plurality of client devices is assigned a stage state;
sending, based on the stage status and the stage state being assigned to the client device, a server state to each client device of the plurality of client devices;
determining a timestamp based on the stage status;
determining, based on the server state, a graphical layout comprising a position and size of each video stream of the plurality of video streams to output to a graphical user interface;
determining a role for each client device, wherein the role comprises at least one of guest, host, or fan, wherein the graphical layout on the client device is based on the role;
based on the timestamp, generating a recording of at least a portion of the graphical user interface associated with the graphical layout transition;
and
providing, to each client device of the plurality of client devices, instructions to display the synchronized arrangement of the plurality of video streams according to the graphical layout.

2. The computer-implemented method of claim 1, wherein selecting the stage status for the subset of the plurality of client devices comprises determining publication of corresponding video streams for the subset of the plurality of client devices that have subscribed to a video channel corresponding to the plurality of video streams.

3. The computer-implemented method of claim 1, wherein determining the client device is assigned the stage state comprises:
determining a location for a video stream of the plurality of video streams corresponding to the client device being assigned the stage state;
receiving audio from the video stream; and
outputting the audio from the video stream to each client device of the plurality of client devices.

4. The computer-implemented method of claim 1, wherein determining the client device is assigned the stage state comprises:
receiving, via an input from a host device, a selection of a stage layout;
determining, based on the input from the host device, a change in the graphical layout of the graphical user interface to the stage layout.

5. The computer-implemented method of claim 1, wherein sending the server state comprises detecting a selection of a user interface component rendered on a host device.

6. The computer-implemented method of claim 1, wherein determining the graphical layout comprises determining the position and size of at least one of: a fan video stream, a host video stream, or a guest video stream, wherein the fan video stream corresponds to a fan accessing the client device being assigned the server state.

7. The computer-implemented method of claim 1, wherein determining the graphical layout comprises:
determining a label of the graphical layout; and
generating an animation or audio effect for the graphical layout.

8. The computer-implemented method of claim 1, further comprising providing a chat interface of the graphical layout for receiving textual inputs or user inputs from each client device of the plurality of client devices.

9. The computer-implemented method of claim 1, further comprising:
receiving, from a host device, an indication to capture a selfie image of a guest and a fan associated with the client device; and
combining an image of the fan from the client device and an image of the guest from a guest device to form the selfie image.

10. The computer-implemented method of claim 1, further comprising:
sending, based on the stage state being assigned to another client device of the plurality of client devices, a new server state;
receiving, from a host device, an instruction to set a first video stream corresponding to the client device at a side position of the graphical layout and to set a second video stream corresponding to the another client device at a center position of the graphical layout;
determining, based on the instruction and the new server state, a change to the graphical layout; and
providing, to each client device of the plurality of client devices, instructions to display the synchronized arrangement of the plurality of video streams according to the change to the graphical layout.

11. A system for outputting a synchronized arrangement of a plurality of video streams, comprising:
one or more processors; and
a memory comprising instructions stored thereon, which when executed by the one or more processors, causes the one or more processors to perform:
selecting a stage status for a subset of the plurality of client devices;
determining, based on the stage status, that a client device of a plurality of client devices is assigned a stage state;
sending, based on the stage status and the stage state being assigned to the client device, a server state to each client device of the plurality of client devices;
determining, based on the server state, a graphical layout comprising a position and size of each video stream of the plurality of video streams to output to a graphical user interface;
sending, based on the stage state being assigned to another client device of the plurality of client devices, a new server state;
determining a timestamp based on the new server state;
determining, based on the new server state, a change to the graphical layout; and
providing, to each client device of the plurality of client devices, instructions to:
display the synchronized arrangement of the plurality of video streams according to the change to the graphical layout, and
based on the timestamp; record of at least a portion of the graphical user interface in association with the change to the graphical layout.

12. The system of claim 11, wherein the instructions that cause the one or more processors to perform selecting the stage status for the subset of the plurality of client devices cause the one or more processors to perform determining publication of corresponding video streams for the subset of the plurality of client devices that have subscribed to a video channel corresponding to the plurality of video streams.

13. The system of claim 11, wherein the instructions that cause the one or more processors to perform determining the client device is assigned the stage state cause the one or more processors to perform:
determining a location for a video stream of the plurality of video streams corresponding to the client device being assigned the stage state;
receiving audio from the video stream; and
outputting the audio from the video stream to each client device of the plurality of client devices.

14. The system of claim 11, wherein the instructions that cause the one or more processors to perform determining the client device is assigned the stage state cause the one or more processors to perform:
receiving, via an input from a host device, a selection of a stage layout;
determining, based on the input from the host device, a change in the graphical layout of the graphical user interface to the stage layout.

15. The system of claim 11, wherein the instructions that cause the one or more processors to perform sending the server state cause the one or more processors to perform detecting a selection of a user interface component rendered on a host device.

16. The system of claim 11, wherein the instructions that cause the one or more processors to perform determining the graphical layout cause the one or more processors to perform determining the position and size of at least one of: a fan video stream, a host video stream, or a guest video stream, wherein the fan video stream corresponds to a fan accessing the client device being assigned the server state.

17. The system of claim 11, wherein the instructions that cause the one or more processors to perform determining the graphical layout cause the one or more processors to perform:
determining a label of the graphical layout;
generating an animation or audio effect for the graphical layout; and
generating a recording of at least a portion of the graphical user interface.

18. The system of claim 11, further comprising stored sequences of instructions, which when executed by the one or more processors, cause the one or more processors to perform:
receiving, from a host device, an indication to capture a selfie image of a guest and a fan associated with the client device; and
combining an image of the fan from the client device and an image of the guest from a guest device to form the selfie image.

19. The system of claim 11, further comprising stored sequences of instructions, which when executed by the one or more processors, cause the one or more processors to perform:
sending, based on the stage state being assigned to another client device of the plurality of client devices, a new server state;
receiving, from a host device, an instruction to set a first video stream corresponding to the client device at a side position of the graphical layout and to set a second video stream corresponding to the another client device at a center position of the graphical layout;
determining, based on the instruction and the new server state, a change to the graphical layout; and
providing, to each client device of the plurality of client devices, instructions to:
display the synchronized arrangement of the plurality of video streams according to the change to the graphical layout, and

20. A non-transitory computer-readable storage medium comprising instructions stored thereon, which when executed by one or more processors, cause the one or more processors to perform operations for outputting a synchronized arrangement of a plurality of video streams, comprising:
selecting a stage status for a subset of the plurality of client devices;
determining, based on the stage status, that a client device of a plurality of client devices is assigned a stage state;
determining a timestamp based on the stage status for each client device;
sending, based on the stage status and the stage state being assigned to the client device, a server state to each client device of the plurality of client devices;
determining, based on the server state, a graphical layout comprising a position and size of each video stream of the plurality of video streams to output to a graphical user interface;
sending, based on the stage state being assigned to another client device of the plurality of client devices, a new server state;
receiving, from a host device, an instruction to set a first video stream corresponding to the client device at a side position of the graphical layout and to set a second video stream corresponding to the another client device at a center position of the graphical layout;
determining, based on the instruction and the new server state, a change to the graphical layout;
and
providing, to each client device of the plurality of client devices, instructions to:
display the synchronized arrangement of the plurality of video streams according to the change to the graphical layout, and
based on the timestamp; record of at least a portion of the graphical user interface in association with the change to the graphical layout.
